(19) United States
(12) Patent Application Publication
(10) Pub. No.: US 2017/0366779 A1
(43) Pub. Date: Dec. 21, 2017

(54) IMAGE PICKUP APPARATUS, CONTROL METHOD FOR IMAGE PICKUP APPARATUS, AND CONTROL PROGRAM FOR IMAGE PICKUP APPARATUS

(71) Applicant: JVC KENWOOD Corporation, Yokohama-shi (JP)

(72) Inventor: Tatsuro Ogawa, Yokohama-shi (JP)

(21) Appl. No.: 15/624,516

(22) Filed: Jun. 15, 2017

(30) Foreign Application Priority Data
Jun. 15, 2016 (JP) 2016-118723

(51) Int. Cl. H04N 5/907; G01N 21/954; H04N 5/232; H04N 5/247

(52) U.S. Cl. CPC H04N 5/907; H04N 5/247; G01N 21/954; H04N 5/23241; H04N 5/23293

(57) ABSTRACT

An image pickup apparatus includes a first image pickup unit configured to shoot a first area and output first image data, a second image pickup unit configured to shoot a second area larger than a first area and output second image data, and a control unit configured to control the first and second image pickup units, in which the control unit creates a first folder and a second folder in a recording unit and stores one of the first and second image data in the first folder and the other of the first and second image data in the second folder, the second folder being created under the first folder.

### CROSS REFERENCE TO RELATED APPLICATION

This application is based upon and claims the benefit of priority from Japanese patent application No. 2016-118723, filed on Jun. 15, 2016, the disclosure of which is incorporated herein in its entirety by reference.

### BACKGROUND

The invention relates to an image pickup apparatus, a control method for an image pickup apparatus, and a control program for an image pickup apparatus.

Cameras that are inserted into narrow spaces into which human beings cannot directly enter, such as pipes, in order to observe their interiors have been known (e.g., Japanese Unexamined Patent Application Publication No. 2007-206258).

For example, images taken inside a narrow space are often images of a local area and hence resemble each other. Therefore, it is often difficult to distinguish where each of these images was taken or what kind of internal space was shot (i.e., photographed, hereinafter simply referred to as “shot”). Further, the image for which the above-described difficulty could occur is not limited to those taken inside narrow spaces. That is, even for other types of images, it is sometime difficult to distinguish where images were taken or what kind of object was shot.

### SUMMARY

An image pickup apparatus according to a first aspect of the invention includes: a first image pickup unit configured to shoot a first area and output first image data; a second image pickup unit configured to shoot a second area and output second image data; and a control unit configured to control the first and second image pickup units, in which the control unit creates a first folder and a second folder in a recording unit and stores one of the first and second image data in the first folder and the other of the first and second image data in the second folder, the second folder being created under the first folder.

A control method for an image pickup apparatus according to a second aspect of the invention includes: a first image pickup step of making a first image pickup unit shoot a first area and output first image data; a second image pickup step of making a second image pickup unit shoot a second area and output second image data; and a storage step of creating a first folder and a second folder in a recording unit and storing the one of the first and second image data in the first folder and the other of the first and second image data in the second folder, the second folder being created under the first folder.

A control program for an image pickup apparatus according to a third aspect of the invention causes a computer to execute: a first image pickup step of making a first image pickup unit shoot a first area and output first image data; a second image pickup step of making a second image pickup unit shoot a second area and output second image data; and a storage step of creating a first folder and a second folder in a recording unit and storing the one of the first and second image data in the first folder and the other of the first and second image data in the second folder, the second folder being created under the first folder.

### BRIEF DESCRIPTION OF THE DRAWINGS

The above and other aspects, advantages and features will be more apparent from the following description of certain embodiments taken in conjunction with the accompanying drawings, in which:

FIG. 1 is a diagram for explaining an image pickup apparatus according to an embodiment and its form of use;

FIGS. 2A and 2B are diagrams for explaining features of images taken by two camera units;

FIG. 3 is a block diagram showing a configuration of an image pickup apparatus;

FIG. 4 shows a tree structure of image data in a storage unit;

FIG. 5 is a flowchart showing a process flow for updating a tree structure;

FIG. 6 is a flowchart showing a process flow for updating a tree structure;

FIG. 7 is a flowchart showing a process flow for updating a tree structure;

FIG. 8 is a flowchart showing a process flow for updating a tree structure; and

FIG. 9 shows an example of automatically-generated report editing.

### DETAILED DESCRIPTION

The invention is explained hereinafter by using embodiments according to the invention. However, the invention, which is defined by the claims, is not limited to the below-described embodiments. Further, all the components/structures explained in the embodiments are not necessarily indispensable as means for solving the problem.

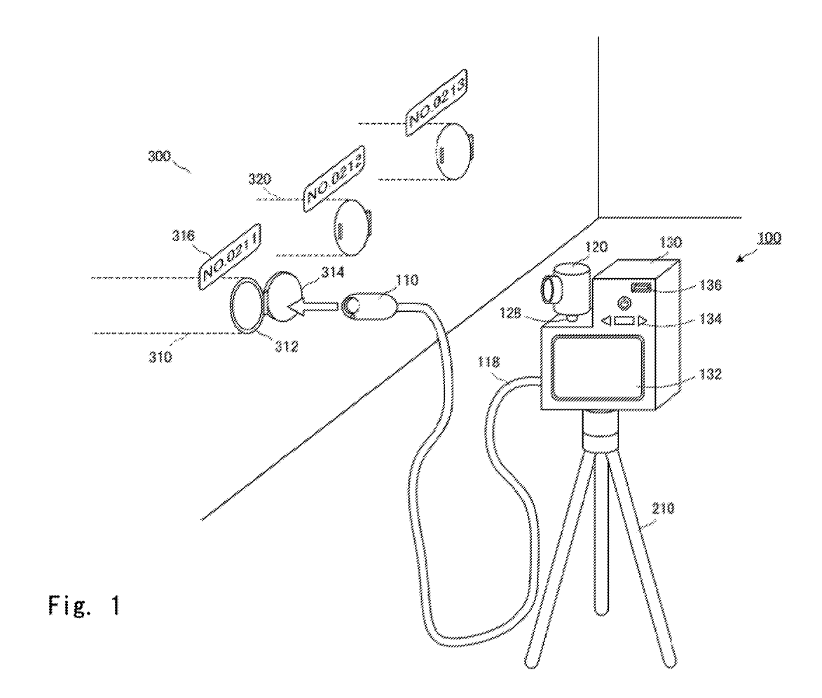

FIG. 1 is a diagram for explaining an image pickup apparatus 100 according to an embodiment and its form of use. Assume, as its used state, a case where an internal space of a pipe 310 embedded in a wall 300 is inspected by using the image pickup apparatus 100 according to this embodiment. The pipe 310 is, for example, a narrow pipe through which a communication cable is laid. The pipe 310 may be branched off inside the wall 300. A user inspects whether the communication cable is properly laid inside the pipe 310 or whether communication cable is not broken by using the image pickup apparatus 100.

The image pickup apparatus 100 mainly includes an inspection camera unit 110 (a first image pickup unit), a peripheral camera unit 120 (a second image pickup unit), and a main body 130. The image pickup apparatus 100 can be disposed, for example, at an arbitrary height by using a tripod 210. The inspection camera unit 110 is manufactured in a small size so that it can be inserted into the internal space of the pipe 310, which is the object to be inspected, and is connected to the main body 130 through a cable 118. Image data of images taken by the inspection camera unit 110 are transmitted to the main body 130 through the cable 118. The inspection camera unit 110 adopts a unit structure suitable for shooting a narrow area, i.e., the internal space of the pipe 310. Details of the unit structure are described later. Note that although a cable is used in this embodiment, the connection is not limited to a wired connection. That is, image data may be transmitted to the main body 130 through wireless connection means, instead of using a wired connection.

The user opens a cap 314 and inserts the inspection camera unit 110 little by little from a pipe opening 312 into the internal space of the pipe 310. The cable 118 has a length that is determined according to a depth inside the internal space the user wants to inspect. Upon completing a predetermined inspection which is performed by taking images of the internal space by using the inspection camera unit 110, the user pulls out the inspection camera unit 110 little by little from the pipe opening 312 and starts an inspection of the next object to be inspected, i.e., an inspection of a pipe 320.

The peripheral camera unit 120 is a camera unit for shooting a peripheral environment (i.e., a surrounding environment) of the image pickup apparatus 100. The peripheral camera unit 120 is connected to the main body 130 through a joint 128. Image data of images taken by the peripheral camera unit 120 are transmitted to the main body 130. The peripheral camera unit 120 adopts a unit structure by which the peripheral camera unit 120 can shoot a wide area around the pipe opening 312 so that, in particular, an image(s) showing a state where the inspection camera unit 110 is inserted in the pipe 310 is taken. Details of the unit structure are described later.

The shooting direction of the peripheral camera unit 120 with respect to the main body 130 can be changed by the joint 128, which is, for example, a universal joint. That is, by the function of the joint 128, the peripheral camera unit 120 can be pointed toward a space including an area that the inspection camera unit 110 shoots. By pointing the peripheral camera unit 120 toward the pipe opening 312, the user can shoot a state where the inspection camera unit 110 is inserted in the object to be inspected or a state where the inspection camera unit 110 has not been inserted in the object to be inspected yet. In this process, the user may take an image so that the image includes an index 316 indicating an identification number of the pipe 310 disposed near the pipe opening 312, so that the taken image is effectively used to identify the inspected object. The index 316 may be temporarily attached to the wall by the user when the pipe is inspected.

The main body 130 includes a display unit 132, which is, for example, an LCD panel. The display unit 132 displays a menu of items related to the setting of the image pickup apparatus 100 as well as images taken by the inspection camera unit 110 and the peripheral camera unit 120.

The main body 130 includes an operation unit 134, which includes, for example, a cross key and a push button. The user may power on/off the image pickup apparatus 100 and/or select an item from the menu related to its setting through the operation unit 134. Further, the user can also select the inspection camera unit 110 or the peripheral camera unit 120 to perform shooting and/or provide a shutter instruction to each of the camera units to perform shooting. Note that the operation unit 134 may be a touch panel superposed on the display unit 132.

The main body 130 includes an external IF 136, which is, for example, a communication terminal such as a USB terminal. The image pickup apparatus 100 can transmit image data of taken images to an external terminal or a peripheral recording device through the external IF 136. Further, the image pickup apparatus 100 can acquire or update a control program for controlling the image pickup apparatus 100 and/or a shooting guide program (which is described later) through the external IF 136. Note that the external IF 136 may be a wireless IF such as a wireless LAN or Bluetooth (Registered Trademark).

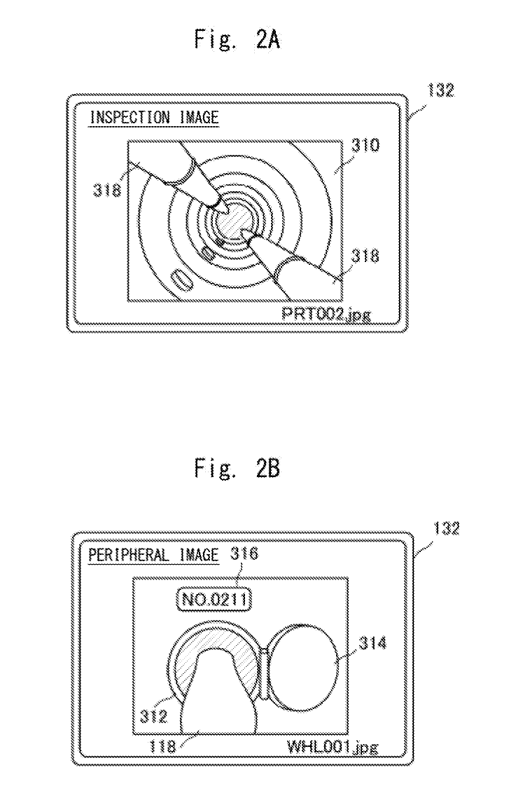

FIG. 2 is a diagram for explaining features of images taken by the two camera units. FIG. 2(a) shows an example in which an inspection image taken by the inspection camera unit 110 is displayed in the display unit 132 and FIG. 2(b) shows an example in which a peripheral image taken by the peripheral camera unit 120 is displayed in the display unit 132.

The user can check, for example, whether a communication cable 318 laid in the pipe 310 is properly laid in pipe 310, whether the communication cable 318 is not broken, whether the pipe 310 is not clogged with a foreign object, and so on by examining the inspection image shown in FIG. 2(a). The inspection image displayed in the display unit 132 may be a live-view image, provided that it is showing an inspection state in which the inspection camera unit 110 is inserted in the pipe 310. Further, the inspection image may be a reproduced still image or a moving image, provided that it is an already-taken image that was taken according to the user's instruction. The display unit 132 also displays information about what kind of image is displayed. For example, the display unit 132 displays “Live-view Image” and/or the name of the image file. In the example shown in the figure, the display unit 132 displays a file name “PRT002.jpg”, so that the user can visually recognize that an already-taken still image is displayed. The identification according to the file name is described later.

The user can check, for example, a state where the cap 314 is opened and the cable 118 is being inserted little by little from the pipe opening 312, and/or check which object to be inspected, which was shot by the inspection camera unit, corresponds to the displayed inspection image based on the identification number indicated by the index 316 by examining the peripheral image shown in FIG. 2(b). The peripheral image displayed in the display unit 132 may be a live-view image. Alternatively, the peripheral image may be a reproduced still image or a moving image, provided that it is an already-taken image that was taken according to the user's instruction. The display unit 132 also displays information about what kind of image is displayed. For example, the display unit 132 displays “Live-view Image” and/or the name of the image file. In the example shown in the figure, the display unit 132 displays a file name “WHL001.jpg”, so that the user can visually recognize that an already-taken still image is displayed. The identification according to the file name is described later.

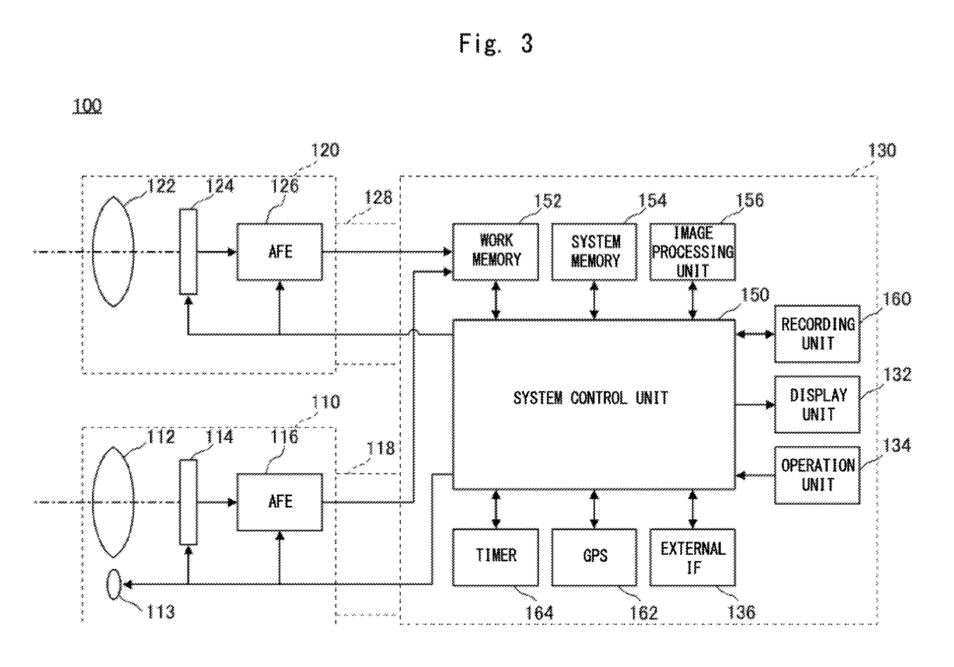

FIG. 3 is a block diagram showing a configuration of the image pickup apparatus 100. As described above, the image pickup apparatus 100 mainly includes the inspection camera unit 110, the peripheral camera unit 120, and the main body 130.

The inspection camera unit 110 mainly includes a lens 112, a light 113, an image pickup device 114, and an AFE (Analog Front End) 116. The lens 112 guides a subject luminous flux incident thereon to the image pickup device 114. The lens 112 may be formed by a group of optical lenses. Because of the nature of the inspection camera unit 110 that it is inserted into and used in an internal space of an object such as a pipe, the lens 112 adopts an optical system suitable for capturing a subject luminous flux coming from a relatively narrow area. In particular, an optical system having a short focal length is preferably used.

The light 113, which is, for example, an LED(s), is illumination that illuminates an internal space of an object and thereby helps the image pickup device 114 to shoot the internal space. The image pickup device 114 is, for example, a CMOS image sensor. The image pickup device 114 may be a monochrome image sensor and/or an infrared image sensor. The image pickup device 114 delivers a pixel signal, which is an output signal thereof, to the AFE 116. The AFE 116 adjusts the level of the pixel signal according to a gain indicated by a system control unit 150, converts the analog pixel signal to a digital signal (i.e., an A/D conversion), and transmits the digital signal as pixel data to the main body 130 through the cable 118.

The peripheral camera unit 120 mainly includes a lens 122, an image pickup device 124, and an AFE (Analog Front End) 126. The lens 122 guides a subject luminous flux incident thereon to the image pickup device 124. The lens 122 may be formed by a group of optical lenses. Because of the nature of the peripheral camera unit 120 that it is used to shoot a surrounding environment of the inspection camera unit 110, the lens 122 adopts an optical system suitable for capturing a subject luminous flux coming from a wider area than that of the lens 112 of the inspection camera unit 110. In particular, an optical system having a focal length longer than that of the lens 112 is preferably used.

The image pickup device 124 is, for example, a CMOS image sensor. The image pickup device 124 should be suitable for the shooting of the surrounding environment and may be an image sensor different from the image pickup device 114. The image pickup device 124 delivers a pixel signal, which is an output signal thereof, to the AFE 126. The AFE 126 adjusts the level of the pixel signal according to a gain indicated by the system control unit 150, converts the analog pixel signal to a digital signal (i.e., an A/D conversion), and transmits the digital signal as pixel data to the main body 130.

The main body 130 includes, in addition to the display unit 132, the operation unit 134, and the external IF 136 explained above, a system control unit 150, a work memory 152, a system memory 154, an image processing unit 156, a recording unit 160, a GPS 162, and a timer 164.

The work memory 152 is formed by, for example, a high-speed nonvolatile memory. The work memory 152 receives pixel data from the AFEs 116 and 126 in succession, combines each of the pixel data into one frame image data, and stores them. The work memory 152 delivers the image data to the image processing unit 156 on a frame-by-frame basis. Further, the work memory 152 may be used as a temporary storage area as appropriate during image processing performed by the image processing unit 156.

The image processing unit 156 preforms various image processes for received image data and thereby generates image data in conformity with a predetermined format. For example, in order to generate still image data in a JPEG format, the image processing unit 156 performs white-balance processing, gamma processing, and the like for one frame image data, and then performs compression processing. For example, in order to generate moving image data in a MPEG-file format, the image processing unit 156 performs white-balance processing, gamma processing, and the like for each frame image, and then performs intra-frame compression processing and inter-frame compression processing. The generated image data is recorded in the recording unit 160. Further, the image data is converted into a display signal(s) by the image processing unit 156 and displayed in the display unit 132.

The recording unit 160 is formed by, for example, a hard disk drive or a nonvolatile recording medium such as a solid-state drive. The recording unit 160 records and holds shot image data in the form of a tree structure (which is described later). The system memory 154 is formed by, for example, a nonvolatile recording medium such as an EEPROM (Registered Trademark). The system memory 154 records and holds constants, variables, setting values, programs, and the like necessary for the operation of the image pickup apparatus 100.

The GPS (Global Positioning System) 162 receives signals from GPS satellites and calculates information about the current location of the image pickup apparatus 100. The timer 164 measures a time in response to a request from the system control unit 150.

The system control unit 150 directly or indirectly controls each of the components included in the image pickup apparatus 100. In particular, the system control unit 150 controls the inspection camera unit 110 and the peripheral camera unit 120 in a selective or parallel manner, and makes each of them output image data. Since one system control unit 150 controls the two camera units, their output image data can be handled in a centralized manner. Since image data that is acquired when the system control unit 150 provides a shooting instruction to the inspection camera unit 110 can be recognized as being image data coming from the inspection camera unit 110, its file name and hierarchical structure are managed so that a user can easily recognize that it is image data coming from the inspection camera unit 110 as described later. Similarly, since image data that is acquired when the system control unit 150 provides a shooting instruction to the peripheral camera unit 120 can be recognized as being image data coming from the peripheral camera unit 120, its file name and hierarchical structure are managed so that a user can easily recognize that it is image data coming from the peripheral camera unit 120 as described later. In addition, these image data are not only managed as two separate image data, but also managed in connection with a series of inspection steps.

The control performed by the system control unit 150 is implemented by a program or the like read from the system memory 154. The display unit 132, the operation unit 134, and the external IF 136 are connected to the system control unit 150. The display unit 132 displays images and the operation unit 134 receives operations under the control of the system control unit 150. Further, the external IF 136 provides/receives data under the control of the system control unit 150.

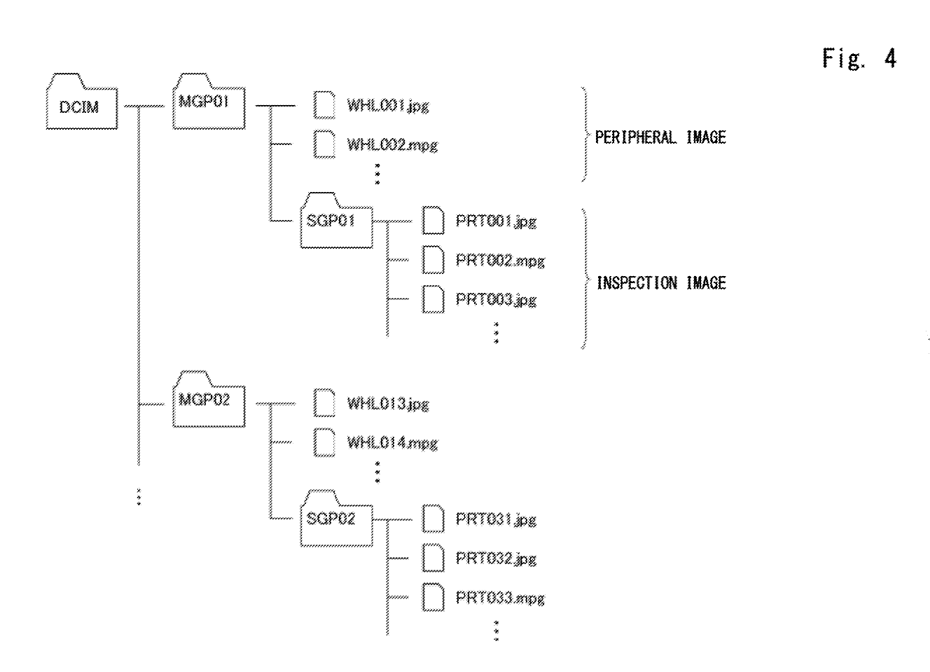

FIG. 4 shows a tree structure of image data in the recording unit 160. Note that the tree structure is, for example, a structure in which one component has one or more child components and each of the child components has one or more grandchild components. That is, a tree structure means a hierarchical structure in which each component has a component(s) thereunder. Note that a component in the lowest layer has no component thereunder. When the pipe 310 is inspected as described above, image data that are obtained through a series of inspection steps are preferably put together in one group and collectively managed. When there are number of inspection images that are obtained by shooting pipe internal spaces over a plurality of inspection sites, it is important that the relation between inspection images and corresponding peripheral images should be recognizable on a group-by-group basis so that it is possible to distinguish in which pipe internal space a given inspection image was taken.

Therefore, in this embodiment, one folder (or one directory) is considered to be one group of image data that are taken through one series of inspection steps. Then, the image data are put together and stored in that group folder (i.e., under that group folder). In FIG. 4, a folder “DCIM” indicates an image folder. Further, folders “MGP01” and “MGP02” are group folders that are created immediately under the image folder DCIM. For example, a series of image data taken in an inspection of the pipe 310 are collectively stored under the folder MGP01 (i.e., in the folder MGP01).

In this embodiment, inspection image data and peripheral image data are stored under the folder MGP01 so that they can be distinguished from each other. Specifically, a sub-folder SGP01 is created under the folder MGP01, which is the group folder, and one of the inspection image data and the peripheral image data is stored under the group folder MGP01 and the other of the inspection image data and the peripheral image data is stored under the sub-folder SGP01. In the example shown in FIG. 4, the peripheral image data shot by the peripheral camera unit 120 are stored under the group folder MGP01 and the inspection image data shot by the inspection camera unit 110 are stored under the sub-folder SGP01.

Note that whether recorded image data is inspection image data or peripheral image data may be determined based on the file name assigned to that image data. Then, each image data may be stored in a corresponding folder as described above. In the example shown in the figure, file names that begin with “WHL” represent peripheral image data and file names that begin with “PRT” represent inspection image data. Any character string may be used, provided that they can be distinguished from each other. Alternatively, when an image is taken, an identifier that indicates by which camera that image is taken may be assigned to the image data. Then, it may be determined later whether the image data is inspection image data or peripheral image data.

By adopting the above-described tree structure, inspection images and their corresponding peripheral images are stored as groups of image data. Therefore, even when pipe internal spaces are shot over a plurality of inspection sites, a user can easily recognize (i.e., distinguish), after the inspection, in which pipe internal space a given inspection image was taken. Incidentally, various techniques can be used to determine which part of a series of image data (i.e., from which image data to which image data in a series of image data) should be put together in one group and stored in one group folder. As a simple example, a user may create a group folder by operating the operation unit 134 prior to an inspection and then prohibit any image data from being stored in that group folder by operating the operation unit 134 again when the inspection is finished. As a result, the tree structure shown in FIG. 4 can be created. Instead of the above-described manual operation by a user, the tree structure shown in FIG. 4 can be automatically created. Specifically, image data is accumulated in a temporary folder until the end of a series of inspection steps is detected by a certain trigger. Then, upon detecting the end of the inspection steps, an updating task for reconstructing the accumulated image data so that it has the tree structure shown in FIG. 4 is performed. Several techniques are explained hereinafter.

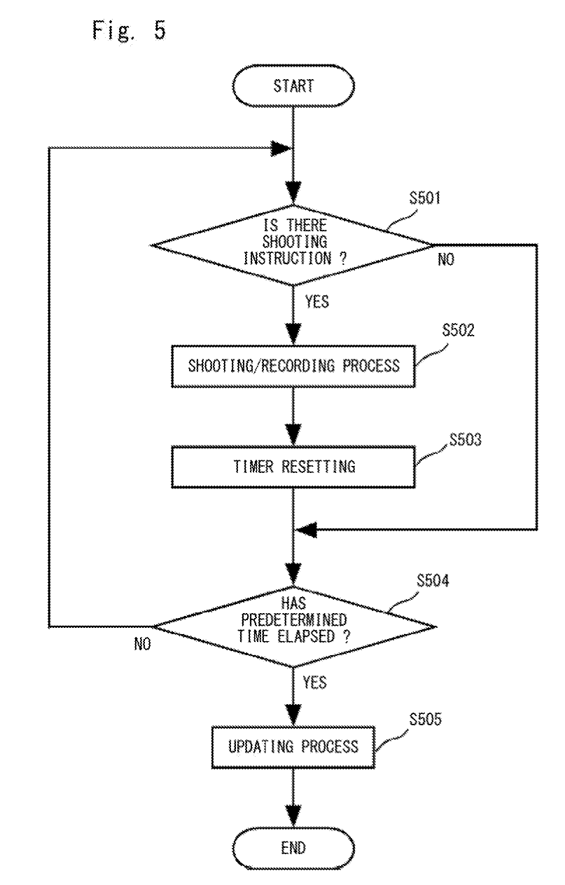

FIG. 5 is a flowchart showing a first process flow for updating a tree structure. A series of processes is started upon the power-on of the image pickup apparatus 100. Note that in the following explanation, it is assumed that a user designates one of the inspection camera unit 110 and the peripheral camera unit 120 as a camera unit that the user wants to use to perform shooting and performs shooting with the designated camera unit, though they are not specifically distinguished from each other. The system control unit 150 waits for a shooting instruction from a user in a step S501. When the system control unit 150 receives the shooting instruction, the system control unit 150 proceeds to a step S502 in which it performs a shooting and recording process (a shooting process). As described above, generated image data is recorded in a temporary folder of the recording unit 160 at this stage. Upon finishing the shooting and recording process, the system control unit 150 proceeds to a step S503 in which it resets the timer 164 and makes the timer 164 start measuring a time from zero.

After the system control unit 150 makes the timer 164 start measuring the time or when there is no shooting instruction in the step S501, the system control unit 150 proceeds to a step S504 in which it determines whether or not a predetermined time has elapsed by using an output from the timer 164. When the predetermined time has not elapsed yet, the system control unit 150 returns to the step S501. Then, when there is another shooting instruction, the system control unit 150 repeats the shooting and recording process. When the system control unit 150 determines that the predetermined time has elapsed, the system control unit 150 proceeds to a step S505.

In the step S505, the system control unit 150 determines that a series of inspection steps has been finished and hence performs a task for updating a tree structure. That is, the system control unit 150 reconstructs the image data accumulated in the temporary folder into a tree structure according to the rule explained above with reference to FIG. 4. Upon completing the updating task, the image pickup apparatus is powered off and the series of processes is finished. The above-described reconstruction is explained hereinafter in a concrete manner based on the example shown in FIG. 4. When it is determined that the series of inspection steps has been finished, among the image data that have been taken in this series of inspection steps, image data that are determined to be peripheral images are stored in the folder MGP01 and image data that are determined to be inspection images are stored in the folder SGP01. Then, when there is a new shooting instruction, it is assumed that another series of inspection steps is started. When it is determined that the other series of inspection steps has been finished, image data that are determined to be peripheral images are stored in the folder MGP02 and image data that are determined to be inspection images are stored in the folder SGP02. In the above-described example, an example in which image data are grouped into and recorded in different folders MGP is shown. However, image data may be grouped into and recorded in different folders SGP (i.e., the folder SGP01 and other folders SGP (not shown)), which are located under the folder MGP01.

According to the above-described process, when no new shooting instruction is provided within a predetermined time period after performing shooting, it is determined that the series of inspection steps has been finished. Therefore, it is possible to reconstruct the tree structure according to the presumed used state of the image pickup apparatus 100. Note that in the above-described process flow, when the shooting and recording process has been completed, the timer is reset and starts measuring a time. However, the timer may start measuring a time at any moment, provided that it is determined based on the shooting and recording process. For example, when the shooting and recording process is a process for a moving image, the time-measuring may be started when the shooting is started.

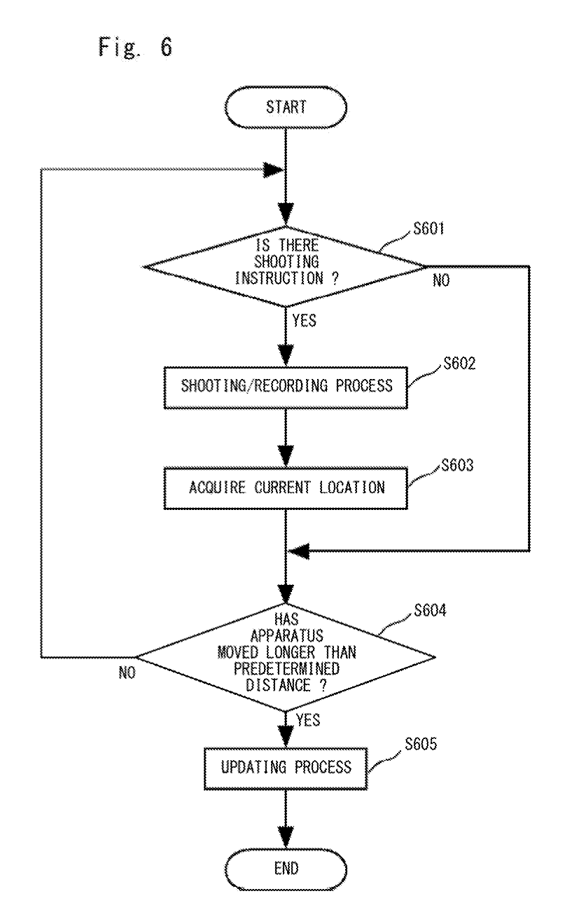

Alternatively, when a user provides an instruction for shooting by using an operation component, the time-measuring may be started upon receiving the user's instruction. FIG. 6 is a flowchart showing a second process flow for updating a tree structure. A series of processes is started upon the power-on of the image pickup apparatus 100. Note that in the following explanation, it is assumed that a user designates one of the inspection camera unit 110 and the peripheral camera unit 120 as a camera unit that the user wants to use to perform shooting and performs shooting with the designated camera unit, though they are not specifically distinguished from each other.

The system control unit 150 waits for a shooting instruction from a user in a step S601. When the system control unit 150 receives the shooting instruction, the system control unit 150 proceeds to a step S602 in which it performs a shooting and recording process. As described above, generated image data is recorded in a temporary folder of the recording unit 160 at this stage. Upon finishing the shooting and recording process, the system control unit 150 proceeds to a step S603 in which it acquires the current location by using an output from the GPS 162.

The system control unit 150 proceeds to a step S604 in which it determines whether or not a distance between a location that was acquired after the previous shooting process and the current location acquired in the step S603 is longer than a predetermined distance. When the distance is not longer than the predetermined distance, the system control unit 150 returns to the step S601. Then, when there is another shooting instruction, the system control unit 150 repeats the shooting and recording process. Note that when the first shooting is performed after the power-on, there is no information about the previous location. Therefore, in that case, the system control unit 150 also returns to the step S601. When the system control unit 150 determines that the distance is longer than the predetermined distance, the system control unit 150 proceeds to a step S605.

In the step S605, the system control unit 150 determines that a series of inspection steps has been finished and hence performs a task for updating a tree structure. Specifically, the system control unit 150 excludes the last shot image from the image data accumulated in the temporary folder and reconstructs the remaining image data into a tree structure according to the rule explained above with reference to FIG. 4. The excluded image data is left as it is in the temporary folder. Upon completing the updating task, the series of processes is finished. When there is another shooting instruction, the system control unit 150 may return to the step S601 and continue the process flow. In this case, another new group folder is created in the step S605. According to the above-described process, when the location of the image pickup apparatus is changed, it is determined that the series of inspection steps in the previous location (i.e., the location before being changed to the new location) has been finished. Therefore, it is possible to reconstruct the tree structure according to the presumed used state of the image pickup apparatus 100.

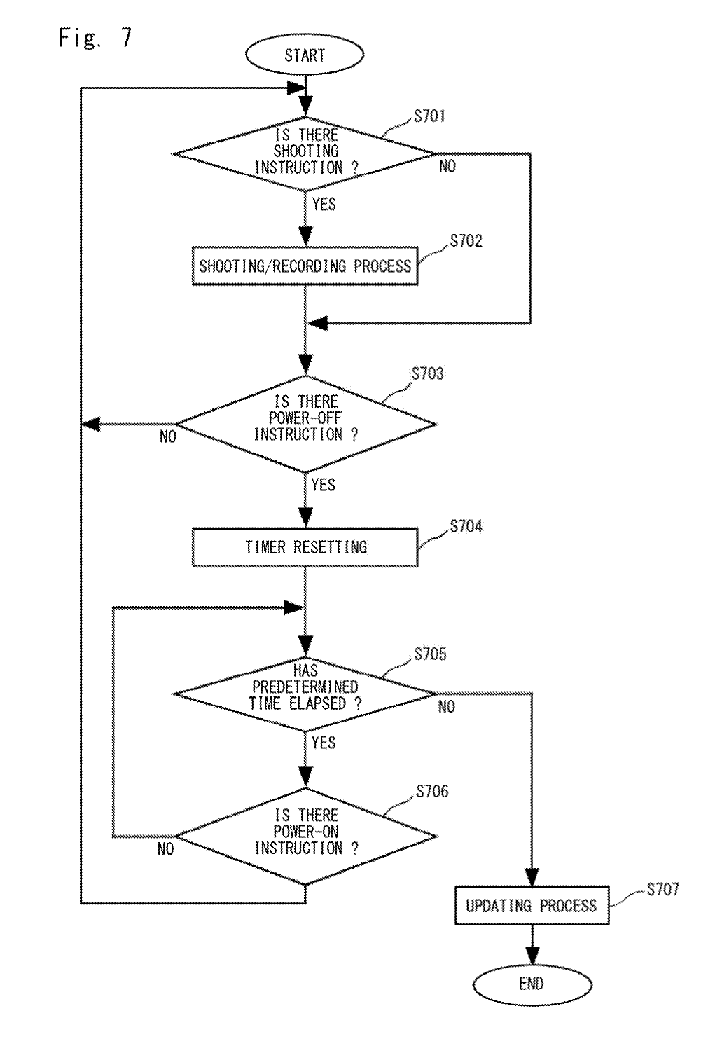

FIG. 7 is a flowchart showing a third process flow for updating a tree structure. A series of processes is started upon the power-on of the image pickup apparatus 100. Note that in the following explanation, it is assumed that a user designates one of the inspection camera unit 110 and the peripheral camera unit 120 as a camera unit that the user wants to use to perform shooting and performs shooting with the designated camera unit, though they are not specifically distinguished from each other.

The system control unit 150 waits for a shooting instruction from a user in a step S701. When the system control unit 150 receives the shooting instruction, the system control unit 150 proceeds to a step S702 in which it performs a shooting and recording process. As described above, generated image data is recorded in a temporary folder of the recording unit 160 at this stage. Upon finishing the shooting and recording process, the system control unit 150 proceeds to a step S703 in which the system control unit 150 determines whether or not it has received a power-off instruction from the user. When the system control unit 150 determines that it has not received the power-off instruction, the system control unit 150 returns to the step S701. When the system control unit 150 determines that it has received the power-off instruction, the system control unit 150 proceeds to a step S704 in which it resets the timer 164 and makes the timer 164 start measuring a time from zero.

The system control unit 150 proceeds to a step S705 in which it determines whether or not a predetermined time has elapsed by using an output from the timer 164. When the predetermined time has not elapsed yet, the system control unit 150 proceeds to a step S706, whereas when the predetermined time has elapsed, the system control unit 150 proceeds to a step S707.

In the step S706, the system control unit 150 determines whether or not it has received a power-on instruction from the user. When the system control unit 150 determines that it has not received the power-on instruction, the system control unit 150 returns to the step S705. When the system control unit 150 determines that it has received the power-on instruction, the system control unit 150 returns to the step S701.

In the step S707, the system control unit 150 determines that a series of inspection steps has been finished and hence performs a task for updating a tree structure. Specifically, the system control unit 150 reconstructs the image data accumulated in the temporary folder into a tree structure according to the rule explained above with reference to FIG. 4. Upon completing the updating task, the image pickup apparatus is powered off and the series of processes is finished. According to the above-described process, when a power-on instruction is provided immediately after a power-off instruction is provided, it is determined that the series of inspection steps has not been finished yet. Therefore, it is possible to reconstruct the tree structure according to the presumed used state of the image pickup apparatus 100.

Note that in the above-described process flow, when a power-off instruction is provided, the timer is reset and starts measuring a predetermined time. However, the second process flow explained above with reference to FIG. 6 may be applied to the above-described process flow and GPS information may be used. Specifically, the current location of the image pickup apparatus is acquired when a power-off instruction is provided. Then, when the image pickup apparatus is moved from that location by a distance longer than a predetermined distance, an updating process is performed. It is expected that when the image pickup apparatus moves to a different location, a series of inspection steps will be newly started. Therefore, according to the above-described process, it is possible to reconstruct the tree structure according to the presumed used state of the image pickup apparatus 100.

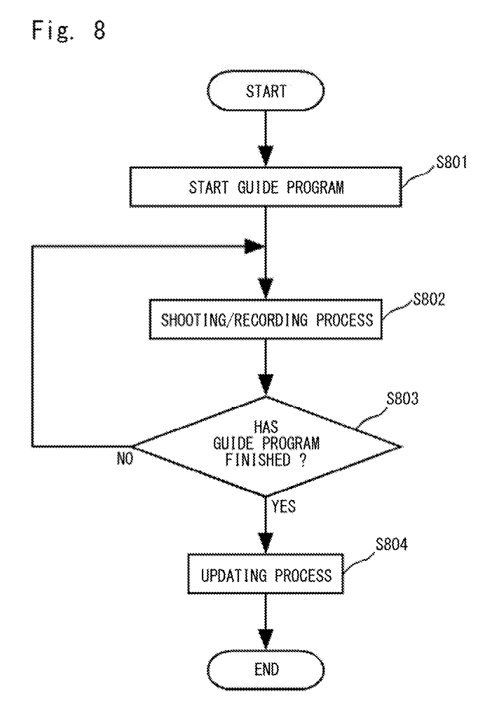

FIG. 8 is a flowchart showing a fourth process flow for updating a tree structure. A series of processes is started upon the power-on of the image pickup apparatus 100. Note that in the following explanation, it is assumed that whether shooting is performed by the inspection camera unit 110 or the peripheral camera unit 120 is determined according to designation by a shooting guide program. Note that the shooting guide program is a program that is created on the assumption that a series of inspection steps is performed, and is a program that is used to lead (or guide) a user to perform a shooting operation, e.g., to guide the user how to set the camera unit and as to at which timing the shooting should be performed by displaying successive guidance images in the display unit 132. The user can complete the series of inspection steps by performing a shooting operation according to the above-described guidance.

In a step S801, the system control unit 150 reads the shooting guide program from the system memory 154 and starts the shooting guide program. In a step S802, the system control unit 150 leads a user along the shooting guide program and performs a shooting and recording process. In a step S803, it is determined whether or not the shooting guide program has been finished. When it is determined that the shooting guide program has not been finished yet, the system control unit 150 returns to the step S802 in which it continues the shooting guide program.

When it is determined that the shooting guide program has been finished in the step S803, the system control unit 150 proceeds to a step S804 in which it determines that a series of inspection steps has been finished and hence performs a task for updating a tree structure. Specifically, the system control unit 150 reconstructs the image data accumulated in the temporary folder into a tree structure according to the rule explained above with reference to FIG. 4. Upon completing the updating task, the image pickup apparatus is powered off and the series of processes is finished. According to the above-described process, when the shooting guide program has been finished, it is determined that the series of inspection steps has been finished. Therefore, it is possible to reconstruct the tree structure according to the presumed used state of the image pickup apparatus 100.

Four process flows have been explained above. A tree structure may be reconstructed by combining these process flows with one another, modifying a part of the process, and/or combining with other process flows. When the tree structure is formed as described above, the user can create a report on an inspection carried out in a respective inspection site more easily. Specifically, by copying image data to a terminal in which the user performs a task for creating a report while maintaining the tree structure, it is possible to implement automatic generation of report editing by using software installed in the terminal.

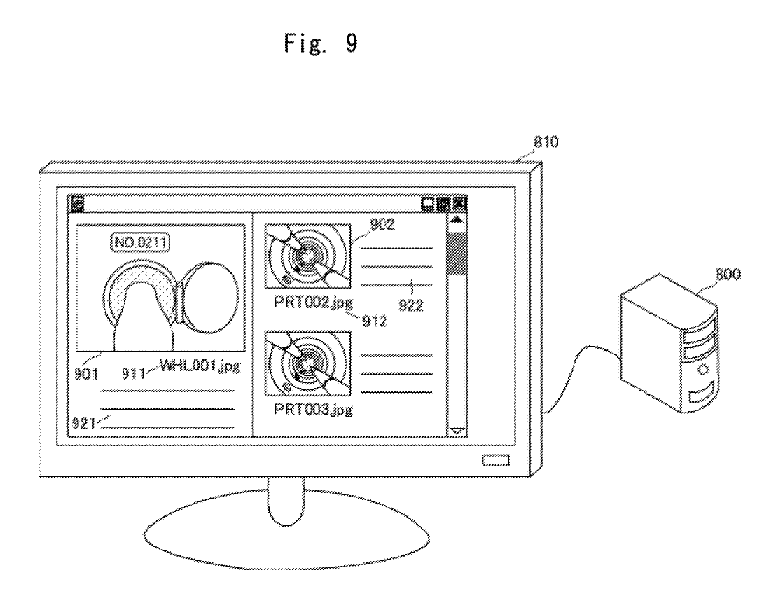

FIG. 9 shows an example of automatically-generated report editing. Software is a kind of DTP and executed by a PC 800 that serves as a work terminal. Image data taken by the image pickup apparatus 100 is copied to a storage device of the PC 800 while maintaining the above-described tree structure. The software urges (or instructs) a user to create a work report on one inspection site for each of the group folders in the tree structure. A specific explanation is given hereinafter by using the group folder MGP01 shown in FIG. 4 as an example. One document format 900 is displayed in a monitor 810. An image 901 of peripheral image data is pasted (i.e., shown) on the first page and its file information 911 is displayed near the image 901. Further, the user is urged to write its explanation in an explanation section 921. When there are a plurality of peripheral image data, the plurality of peripheral image data are shown according to the user's instruction. An image 902 of corresponding inspection image data is pasted on the second page and its file information 912 is displayed near the image 902. Further, the user is urged to write its explanation in an explanation section 922. When there are a plurality of inspection image data, their images are displayed in a repetitive and similar manner. Further, it is configured so that another group folder MGP02 can be similarly displayed. The user can complete the report by filling in other sections along the layout. When the report is in the form of a digital file, a moving image can be embedded as an image.

In the above-described embodiments, the image pickup apparatus 100 that inspects pipes is explained. However, the image pickup apparatus 100 is not limited to those for inspecting pipes. The image pickup apparatus 100 is applicable to various purposes in which the inspection camera unit 110 shoots a narrow area and the peripheral camera unit 120 shoots an area wider than the area for the inspection camera unit 110. Further, the configuration as the image pickup apparatus is not limited to that of the image pickup apparatus 100 and can be widely modified according to the purpose. For example, it is applied to an endoscope in which an organ of a human body is shot as an internal space of an object. When it is applied to an endoscope, it is possible, for example, to distinguish whether an endoscope camera unit, which corresponds to the inspection camera unit, was inserted into a nasal cavity or into an abdominal cavity by shooting a surface of the human body including the part where the endoscope camera unit was inserted by the peripheral camera unit at the same time. In the case where the endoscope is equipped with a mechanism for changing the shooting direction of the endoscope camera, the peripheral camera unit is preferably disposed in a holding part of the endoscope which also serves an operation unit.

In the above-described embodiments, a relation between inspection image data and peripheral image data is shown by using a tree structure in the recording unit. However, the provision of information about the relation is not limited to the use of a tree structure. For example, by describing file information of relevant image data in accessory information (such as EXIF information) of a respective image file, it is possible to recognize the relation between image data later.

While the invention has been described in terms of several embodiments, those skilled in the art will recognize that the invention can be practiced with various modifications within the spirit and scope of the appended claims and the invention is not limited to the examples described above.

Further, the scope of the claims is not limited by the embodiments described above.

Furthermore, it is noted that, Applicant's intent is to encompass equivalents of all claim elements, even if amended later during prosecution.

A program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

What is claimed is:

1. An image pickup apparatus comprising:
a first image pickup unit configured to shoot a first area and output first image data;
a second image pickup unit configured to shoot a second area and output second image data; and
a control unit configured to control the first and second image pickup units, wherein
the control unit creates a first folder and a second folder in a recording unit and stores one of the first and second image data in the first folder and the other of the first and second image data in the second folder, the second folder being created under the first folder.

2. The image pickup apparatus according to claim 1, wherein the control unit creates the first and second folders and stores the first and second image data therein when a predetermined condition is satisfied.

3. The image pickup apparatus according to claim 2, wherein the predetermined condition is that a predetermined time elapses, the predetermined time being determined in advance based on a shooting process.

4. The image pickup apparatus according to claim 2, wherein the predetermined condition is that the image pickup apparatus moves a distance longer than a predetermined distance from a place where the image pickup apparatus has performed a shooting process.

5. The image pickup apparatus according to claim 2, wherein the predetermined condition is that a predetermined time elapses after a power-off instruction is received.

6. The image pickup apparatus according to claim 2, wherein the predetermined condition is that the image pickup apparatus moves a distance longer than a predetermined distance from a place where the image pickup apparatus has received a power-off instruction.

7. The image pickup apparatus according to claim 2, wherein the predetermined condition is that a program for guiding an operation of the image pickup apparatus is finished.

8. A control method for an image pickup apparatus, comprising:
a first image pickup step of making a first image pickup unit shoot a first area and output first image data;
a second image pickup step of making a second image pickup unit shoot a second area and output second image data; and
a storage step of creating a first folder and a second folder in a recording unit and storing the one of the first and second image data in the first folder and the other of the first and second image data in the second folder, the second folder being created under the first folder.

9. A storage medium storing a control program for an image pickup apparatus for causing a computer to execute:
a first image pickup step of making a first image pickup unit shoot a first area and output first image data;
a second image pickup step of making a second image pickup unit shoot a second area and output second image data; and
a storage step of creating a first folder and a second folder in a recording unit and storing the one of the first and second image data in the first folder and the other of the first and second image data in the second folder, the second folder being created under the first folder.
